(19) United States
(12) Patent Application Publication
(10) Pub. No.: US 2010/0203323 A1
(43) Pub. Date: Aug. 12, 2010

(54) PRESSURE-SENSITIVE ADHESIVE TAPE AND METHOD OF PRODUCING THE TAPE

(75) Inventors: Yoshio Terada, Ibaraki-shi (JP); Shozo Kawazoe, Ibaraki-shi (JP); Yoshinori Yoshida, Ibaraki-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: NITTO DENKO CORPORATION, Ibaraki-shi (JP)

(21) Appl. No.: 12/677,405

(22) PCT Filed: Aug. 26, 2008
(86) PCT No.: PCT/JP2008/065135

§ 371 Date: Mar. 10, 2010

(30) Foreign Application Priority Data
Sep. 11, 2007 (JP) 2007-235130
Sep. 25, 2007 (JP) 2007-246885

(51) Int. Cl. B32B 7/10; B05D 5/10

(52) U.S. Cl. 428/332; 427/208.4

(57) ABSTRACT

Provided are a pressure-sensitive adhesive tape, which has a needed pressure-sensitive adhesive force for an adherend, can remove even foreign matter at a submicron level without contaminating a cleaning site, is excellent in heat resistance, exerts a sufficient pressure-sensitive adhesive force and a sufficient cohesive force even at a high temperature, and can be easily peeled without generating any adhesive residue on the adherend upon peeling from the adherend after its use, and a method of producing the tape. The pressure-sensitive adhesive tape of the present invention includes, on a surface of a support, an assembly layer of oblique columnar structures each protruding at an elevation angle of less than 90° from the surface of the support, the oblique columnar structures each having an aspect ratio of 1 or more. The method of producing a pressure-sensitive adhesive tape of the present invention is a method of producing, on a surface of a support, a pressure-sensitive adhesive tape including an assembly layer of oblique columnar structures each protruding at an elevation angle of less than 90° from the surface of the support, the oblique columnar structures each having an aspect ratio of 1 or more, the method including forming the oblique columnar structures on the surface of the support by an oblique deposition process.

### TECHNICAL FIELD

The present invention relates to a pressure-sensitive adhesive tape which has a needed pressure-sensitive adhesive force for an adherend, is excellent in heat resistance, and, in particular, can be easily peeled without generating any pressure-sensitive adhesive residue on the adherend upon peeling, and a method of producing the tape.

### BACKGROUND ART

In recent years, a pressure-sensitive adhesive tape has been widely used, for example, for the production of electronic parts, structures, and automobiles. In those applications, a large stress is applied to the pressure-sensitive adhesive tape at the time of the use, and the pressure-sensitive adhesive tape is used at a high temperature in many cases. Accordingly, a pressure-sensitive adhesive is requested to have a high cohesive force and heat resistance. In particular, the pressure-sensitive adhesive tape used in the production process of an electronic part, a semiconductor device, a flat display such as an LCD or PDP, or the like, is generally subjected to processes to be performed at a high temperature of 100° C. or higher in many cases. Therefore, there has been requested a pressure-sensitive adhesive tape which exerts a sufficient pressure-sensitive adhesive force and a sufficient cohesive force at a high temperature, and which can be easily peeled and removed from an adherend after its use.

Investigations have been conducted on the blending of any one of the various inorganic fillers into a pressure-sensitive adhesive in order that a pressure-sensitive adhesive tape may exert a sufficient pressure-sensitive adhesive force and a sufficient cohesive force at a high temperature (see, for example, Patent Documents 1 and 2). However, when the pressure-sensitive adhesive tape is peeled and removed from an adherend at the time of reworking or after the completion of a production process, the pressure-sensitive adhesive containing an inorganic filler easily undergoes a cohesive failure, and hence an adhesive residue is generated on the adherend.

In addition, a method of removing foreign matter by cleaning with a pressure-sensitive adhesive tape (see, for example, Patent Document 3) involves the following possibility, though the method is an excellent method of effectively removing the foreign matter. That is, a pressure-sensitive adhesive may adhere too strongly to a cleaning site to be peeled, or the pressure-sensitive adhesive generates an adhesive residue on the cleaning site, thereby contaminating the site instead. In addition, a reduction in pressure-sensitive adhesive force for preventing the adhesive residue involves the following problem. That is, all-important dusting performance for the foreign matter deteriorates.

Further, foreign matter that causes a problem in any one of the various substrate-treating apparatuses has been recently of a size at a submicron (1 μm or less) level, and hence it is not easy to remove the foreign matter of the size reliably.

### Patent Document 1: JP 2005-344008 A

### Patent Document 2: JP 2005-154581 A

### Patent Document 3: JP 10-154686 A

### DISCLOSURE OF THE INVENTION

### Problems to be Solved by the Invention

An object of the present invention is to provide a pressure-sensitive adhesive tape which has a needed pressure-sensitive adhesive force for an adherend, can remove even foreign matter at a submicron level without contaminating a cleaning site, is excellent in heat resistance, exerts a sufficient pressure-sensitive adhesive force and a sufficient cohesive force even at a high temperature, and can be easily peeled without generating any adhesive residue on the adherend upon peeling from the adherend after its use, and a method of producing the tape.

### Means for Solving the Problems

A pressure-sensitive adhesive tape of the present invention includes, on a surface of a support, an assembly layer of oblique columnar structures each protruding at an elevation angle of less than 90° from the surface of the support, the oblique columnar structures each having an aspect ratio of 1 or more.

In a preferred embodiment, the above oblique columnar structures each have a length of 100 nm or more.

In a preferred embodiment, the number of the above oblique columnar structures per unit area of the above surface of the support is 1×10⁸ structures/cm² or more.

In a preferred embodiment, a surface of the above assembly layer has a water contact angle of 10° or less.

In a preferred embodiment, the above assembly layer includes a cleaning layer.

In a preferred embodiment, the pressure-sensitive adhesive tape of the present invention is used in producing an electronic part.

A method of producing a pressure-sensitive adhesive tape of the present invention is a method of producing, on a surface of a support, a pressure-sensitive adhesive tape including an assembly layer of oblique columnar structures each protruding at an elevation angle of less than 90° from the surface of the support, the oblique columnar structures each having an aspect ratio of 1 or more, the method including forming the oblique columnar structures on the surface of the support by an oblique deposition process.

In a preferred embodiment, a vacuum deposition apparatus is used in the above oblique deposition process.

In a preferred embodiment, an ultimate pressure in the above vacuum deposition apparatus is 1×10⁻³ torr or less.

In a preferred embodiment, vapor deposition of a deposition material in the above vacuum deposition apparatus is performed by heating and vaporization with electron beams.

In a preferred embodiment, the above oblique deposition process is performed by depositing a deposition material from the vapor onto the above support delivered by a roll.

In a preferred embodiment, the above oblique deposition process involves obliquely depositing a deposition material from the vapor onto the above support by providing a partial shield between a deposition source and the support.

In a preferred embodiment, the above oblique columnar structures each have a length of 100 nm or more.

In a preferred embodiment, the number of the above oblique columnar structures per unit area of the above surface of the support is 1×10⁸ structures/cm² or more.

In a preferred embodiment, a surface of the above assembly layer has a water contact angle of 10° or less.

In a preferred embodiment, the above assembly layer includes a cleaning layer.

In a preferred embodiment, the pressure-sensitive adhesive tape obtained by the present invention is used in producing an electronic part.

### EFFECT OF THE INVENTION

According to the present invention, there can be provided a pressure-sensitive adhesive tape which has a needed pressure-sensitive adhesive force for an adherend, can remove even foreign matter at a submicron level without contaminating a cleaning site, is excellent in heat resistance, exerts a sufficient pressure-sensitive adhesive force and a sufficient cohesive force even at a high temperature, and can be easily peeled without generating any adhesive residue on the adherend upon peeling from the adherend after its use.

Such effect as described above can be expressed by providing the surface of a support with a large number of oblique columnar structures each protruding in an oblique direction at an elevation angle of less than 90° from the surface of the support, setting the aspect ratio of each of the oblique columnar structures to 1 or more, and causing an assembly layer of those oblique columnar structures to function as a pressure-sensitive adhesive.

In addition, according to the present invention, there can be provided a method of producing a pressure-sensitive adhesive tape which has a needed pressure-sensitive adhesive force for an adherend, can remove even foreign matter at a submicron level without contaminating a cleaning site, is excellent in heat resistance, exerts a sufficient pressure-sensitive adhesive force and a sufficient cohesive force even at a high temperature, and can be easily peeled without generating any adhesive residue on the adherend upon peeling from the adherend after its use.

Such effect as described above can be expressed by producing, on the surface of a support, a pressure-sensitive adhesive tape including an assembly layer of oblique columnar structures each protruding at an elevation angle of less than 90° from the surface of the support and each having an aspect ratio of 1 or more by a method involving forming the oblique columnar structures on the surface of the support by an oblique deposition process.

### BRIEF DESCRIPTION OF THE DRAWINGS

FIG. 1 is an outline sectional view of a preferred embodiment of a pressure-sensitive adhesive tape of the present invention.

FIG. 2 is an outline sectional view of the preferred embodiment of the pressure-sensitive adhesive tape of the present invention, the outline sectional view describing an elevation angle α.

FIG. 3 is an outline sectional view of a preferred embodiment of an oblique columnar structure in the pressure-sensitive adhesive tape of the present invention.

FIG. 4 is an outline sectional view of another preferred embodiment of the oblique columnar structure in the pressure-sensitive adhesive tape of the present invention.

FIG. 5 is an outline sectional view of a preferred embodiment of an apparatus used in an oblique deposition process.

FIG. 6 is a sectional SEM photograph of a pressure-sensitive adhesive tape (1) obtained in Example 1.

FIG. 7 is a sectional SEM photograph of a pressure-sensitive adhesive tape (2) obtained in Example 2.

FIG. 8 is a sectional SEM photograph of a pressure-sensitive adhesive tape (3) obtained in Example 3.

FIG. 9 is a sectional SEM photograph of a pressure-sensitive adhesive tape obtained in Comparative Example 2.

FIG. 10 is a sectional SEM photograph of a pressure-sensitive adhesive tape (4) obtained in Example 4.

### DESCRIPTION OF SYMBOLS

10 support
20 assembly layer
30 oblique columnar structure
40 deposition roll
50 shield
60 deposition source
100 pressure-sensitive adhesive tape

### BEST MODE FOR CARRYING OUT THE INVENTION

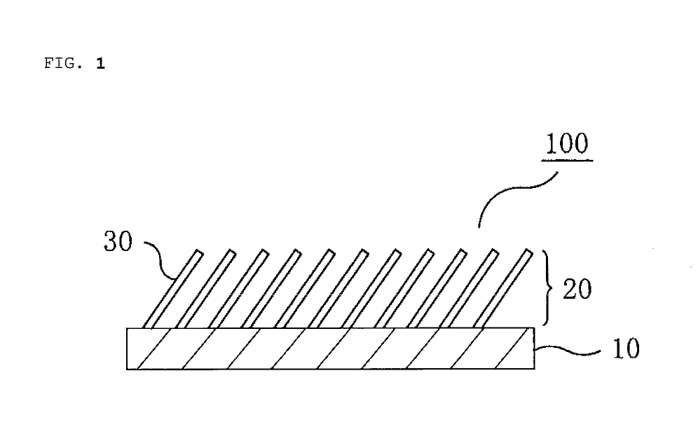

FIG. 1 is an outline sectional view of a pressure-sensitive adhesive tape as a preferred embodiment of the present invention. In addition, FIG. 1 is an outline sectional view of a pressure-sensitive adhesive tape as a preferred embodiment obtained by a production method of the present invention. A pressure-sensitive adhesive tape 100 illustrated in the figure has a support 10 and an assembly layer 20 of oblique columnar structures 30. The assembly layer 20 of the oblique columnar structures 30 may be provided on the entire surface of the support 10, or may be provided only on part of the surface of the support 10. The assembly layer 20 of the oblique columnar structures 30 may be provided on one surface of the support 10, or may be provided on each of both surfaces of the support 10.

The assembly layer 20 of the oblique columnar structures is an assembly layer of the multiple oblique columnar structures 30. The assembly layer 20 of the oblique columnar structures can act as a pressure-sensitive adhesive layer or a cleaning layer.

When the assembly layer of the multiple oblique columnar structures is formed, a pressure-sensitive adhesive force between the pressure-sensitive adhesive tape of the present invention and an adherend is expressed by a steric entanglement effect with the adherend or a van der Waals force effect in association with an increase in surface area. As a result, a pressure-sensitive adhesive tape capable of efficiently removing, in particular, minute foreign matter with a size of a submicron or less can be provided.

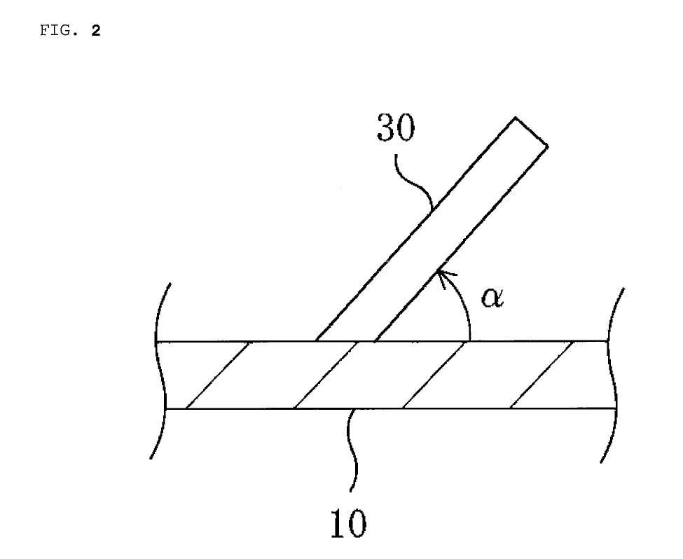

As illustrated in FIG. 2, the oblique columnar structures 30 each protrude from the surface of the support 10 at an elevation angle α of less than 90° from the surface of the support. The elevation angle α is preferably 10 to 85°, more preferably 20 to 80°, or still more preferably 30 to 70°. When the elevation angle α is less than 90°, the pressure-sensitive adhesive tape of the present invention or the pressure-sensitive adhesive tape obtained by the production method of the present invention has a needed pressure-sensitive adhesive force for an adherend, can remove even foreign matter at a submicron level without contaminating a cleaning site, and can be easily peeled upon peeling from the adherend after its use.

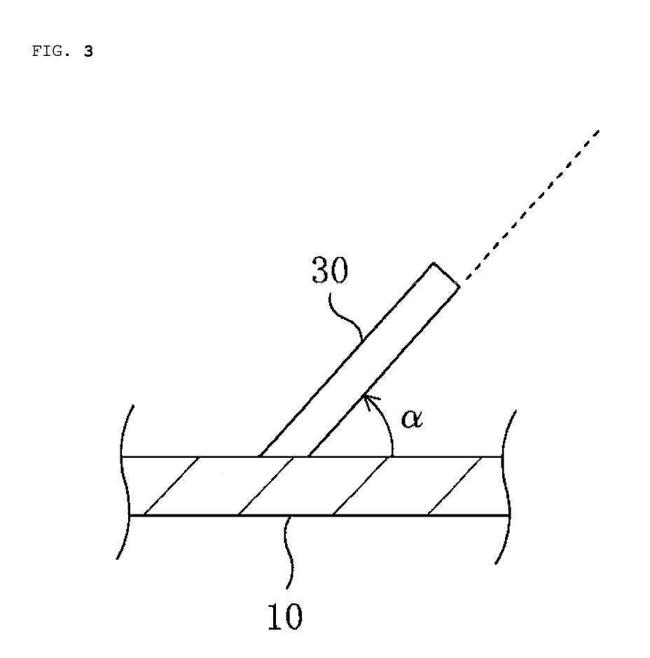

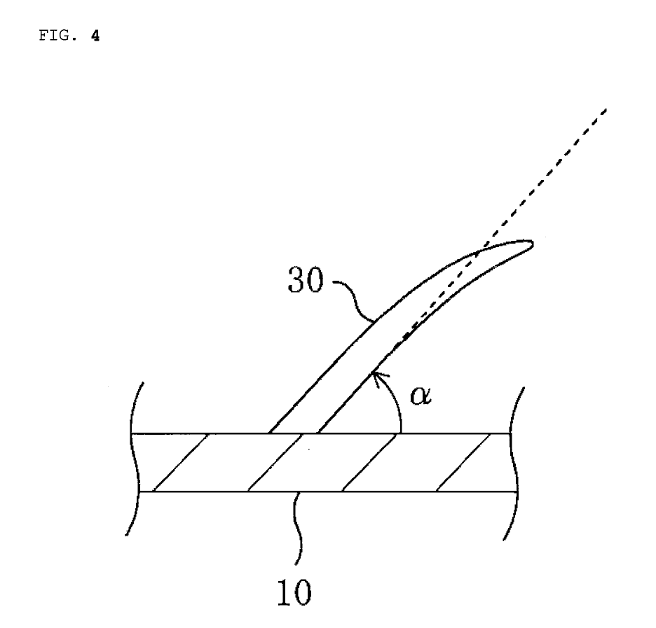

The oblique columnar structures 30 may each protrude in a substantially straight line at an elevation angle α from the surface of the support 10 as illustrated in FIG. 3. Alternatively, the oblique columnar structures 30 may each be of a sinuous shape after having protruded from the surface of the support 10 at an initial elevation angle α as illustrated in FIG. 4.

The oblique columnar structures each have a columnar structure. The term “columnar structure” comprehends not only a strictly columnar structure but also a substantially columnar structure. Preferred examples of the columnar structure include a cylindrical structure, a polygonal columnar structure, a cone-like structure, and a fibrous structure. In addition, the sectional shape of the columnar structure may be uniform over the entirety of the columnar structure, or may be nonuniform.

The above oblique columnar structures each have an aspect ratio of 1 or more. The term “aspect ratio” as used in the present invention refers to a ratio between the length (A) of each of the oblique columnar structures and the length (B) of the diameter of a portion having the thickest diameter of the oblique columnar structure (provided that the lengths (A) and (B) have the same unit). The above aspect ratio is preferably 2 to 20 or more preferably 3 to 10. When the aspect ratio of each of the above oblique columnar structures falls within the above range, minute foreign matter, or preferably foreign matter at a submicron level, can be simply, reliably, and sufficiently removed. Such effect is probably attributable to a van der Waals force acting between the assembly layer of the oblique columnar structures and the cleaning site (adherend).

The oblique columnar structures each have a length of preferably 100 nm or more, more preferably 200 to 100,000 nm, still more preferably 300 to 10,000 nm, or particularly preferably 500 to 5000 nm. When the length of each of the above oblique columnar structures falls within the above range, minute foreign matter, or preferably foreign matter at a submicron level, can be simply, reliably, and sufficiently removed. Such effect is probably attributable to a van der Waals force acting between the assembly layer of the oblique columnar structures and the cleaning site (adherend).

The oblique columnar structures each have a diameter of preferably 1000 nm or less, more preferably 10 to 500 nm, or still more preferably 100 to 300 nm. When the diameter of each of the above oblique columnar structures falls within the above range, minute foreign matter, or preferably foreign matter at a submicron level, can be simply, reliably, and sufficiently removed. Such effect is probably attributable to a van der Waals force acting between the assembly layer of the oblique columnar structures and the cleaning site (adherend).

The length and diameter of the oblique columnar structures have only to be measured by any appropriate measurement method. The measurement is preferably performed with, for example, a scanning electron microscope (SEM) in terms of ease of measurement and the like. In the case of the measurement with the scanning electron microscope (SEM), the length and diameter of the oblique columnar structures can be determined by, for example, sticking the pressure-sensitive adhesive tape of the present invention to an SEM observation sample board and observing the tape from a side direction.

The number of the oblique columnar structures per unit area of the surface of the support is preferably 1×10⁸ structures/cm² or more, more preferably 1×10⁸ to 1×10¹² structures/cm², or still more preferably 3×10⁸ to 1×10¹⁰ structures/cm². When the number of the oblique columnar structures per unit area of the surface of the support falls within the above range, minute foreign matter, or preferably foreign matter at a submicron level, can be simply, reliably, and sufficiently removed. Such effect is probably attributable to a van der Waals force acting between the assembly layer of the oblique columnar structures and the cleaning site (adherend).

Any appropriate material can be adopted for the support in the pressure-sensitive adhesive tape of the present invention or the support in the pressure sensitive adhesive tape obtained by the production method of the present invention. For example, there are used: a sheet or a substrate formed of an organic polymer resin such as a polyimide (PI)-based resin, a polyester (PET)-based resin, a polyethylene naphthalate (PEN)-based resin, a polyether sulfone (PES)-based resin, a polyether ether ketone (PEEK)-based resin, a polyarylate (PAR)-based resin, an aramid-based resin, a liquid crystal polymer (LCP) resin, a fluorine-based resin, an acrylic resin, an epoxy-based resin, a polyolefin-based resin, polyvinyl chloride, EVA, PMMA, and POM; and also a quartz substrate; a glass substrate; and a substrate formed of, for example, an inorganic material such as a silicon wafer. Of those, polyimide-based resin sheet and a silicon wafer are particularly suitably used because those materials are heat resistant.

In the pressure-sensitive adhesive tape of the present invention or the pressure-sensitive adhesive tape obtained by the production method of the present invention, adhesiveness between each of the oblique columnar structures and the support may be improved by subjecting the surface of the support to a plasma (sputtering) treatment, corona discharge, ultraviolet irradiation, a flame, electron beam irradiation, chemical conversion, an etching treatment such as oxidation, or an undercoating treatment with organic matter in advance. Alternatively, the surface may be subjected to dusting and cleaning by solvent cleaning, ultrasonic cleaning, or the like as required.

Any appropriate thickness can be adopted as the thickness of the support. In the case of, for example, a sheet-like support, the thickness is preferably 10 to 250 μm. In the case of a substrate-like support, the thickness is preferably 0.1 to 10 mm. It should be noted that the support may be a single layer, or may be a laminate of two or more layers.

Any appropriate material can be adopted for each of the oblique columnar structures in the pressure-sensitive adhesive tape of the present invention or the pressure-sensitive adhesive tape obtained by the production method of the present invention. For example, there may be used: metals such as aluminum, zinc, gold, silver, platinum, nickel, chromium, copper, platinum, and indium; inorganic materials such as sapphire, silicon carbide (SiC), and gallium nitride (GaN); and oxides such as silicon monoxide (SiO), silicon dioxide (SiO₂), aluminum oxide (Al₂O₃), cerium oxide (CeO₂), chromium oxide (Cr₂O₃), gallium oxide (Ga₂O₃), hafnium oxide (HfO₂), tantalum pentoxide (Ta₂O₅), yttrium oxide (Y₂O₃), tungsten oxide (WO₃), titanium monoxide (TiO), titanium dioxide (TiO₂), titanium pentoxide (Ti₃O₅), nickel oxide (NiO), magnesium oxide (MgO), ITO (In₂O₃+SnO₂), niobium pentoxide (Nb₂O₅), zinc oxide (ZnO), and zirconium oxide (ZrO₂). Further, there may be used: polyimides; fluorine-based materials such as aluminum fluoride, calcium fluoride, serium fluoride, lanthanum fluoride, lithium fluoride, magnesium fluoride, neodymium fluoride, and sodium fluoride; resins such as silicone; and the like. Those materials may be used alone or in a mixture, or there may be adopted a multilayer structure of two or more layers. In particular, there are suitably used oxides such as silicon dioxide (SiO₂) and titanium dioxide (TiO₂) which are hydrophilic materials.

The surface of the assembly layer in the pressure-sensitive adhesive tape of the present invention or the pressure-sensitive adhesive tape obtained by the production method of the present invention has a water contact angle of preferably 10° or less, more preferably 8° or less, or still more preferably 5° or less. When the water contact angle of the surface of the assembly layer falls within the above range, the wettability of the surface of the assembly layer improves, adhesiveness with an adherend improves, and a pressure-sensitive adhesive force or removing performance for foreign matter enlarges.

The surface of the assembly layer in the pressure-sensitive adhesive tape of the present invention or the pressure-sensitive adhesive tape obtained by the production method of the present invention has a surface free energy of preferably 70 mJ/m² or more, more preferably 73 mJ/m² or more, or still more preferably 75 mJ/m² or more. When the surface free energy of the surface of the assembly layer falls within the above range, the wettability of the surface of the assembly layer improves, adhesiveness with an adherend improves, and a pressure-sensitive adhesive force or removing performance for foreign matter enlarges.

The term “surface free energy” as used herein refers to a value for the surface free energy of a solid determined by measuring a contact angle with each of water and methylene iodide with respect to the surface of the solid, substituting the measured value and a value for the surface free energy of the liquid for contact angle measurement (known from a document) into the following equation (1) derived from Young's equation and the extended Fowkes's equation, and solving the resultant two equations as simultaneous linear equations.

(1+cos θ)r_{L}=2√(r_{S}^{d}r_{L}^{d})+2√(r_{S}^{v}r_{L}^{v}) (1)

It should be noted that the definition of each of the symbols in the equation is as described below.

θ: The contact angle
r_{L}: The surface free energy of the liquid for contact angle measurement
r_{L}^{d}: A dispersion force component in rL
r_{L}^{v}: A polarity force component in rL
r_{S}^{d}: A dispersion force component in the surface free energy of the solid
r_{S}^{v}: A polarity force component in the surface free energy of the solid

Any appropriate condition can be adopted for the thickness of the assembly layer in the pressure-sensitive adhesive tape of the present invention or the pressure-sensitive adhesive tape obtained by the production method of the present invention to such an extent that the object of the present invention can be achieved. The thickness is preferably 100 nm or more, more preferably 200 to 10,000 nm, or still more preferably 500 to 5000 nm. When the thickness falls within such range, minute foreign matter, or preferably foreign matter at a submicron level, can be simply, reliably, and sufficiently removed.

It is preferred that the above assembly layer be substantially free of any pressure-sensitive adhesive force. The expression “substantially free of any pressure-sensitive adhesive force” as used herein refers to a state where a pressure-sensitive tack that epitomizes a function of pressure-sensitive adhesiveness is absent when the essence of pressure-sensitive adhesion is defined as friction as resistance against a slip. The pressure-sensitive tack is such that a pressure-sensitive substance expresses an elastic modulus of up to 1 MPa in accordance with, for example, Dahlquist's criteria.

A protective film may be used for protecting the surface of the assembly layer in the pressure-sensitive adhesive tape of the present invention or the pressure-sensitive adhesive tape obtained by the production method of the present invention. The protective film can be peeled at an appropriate stage such as the time point at which the tape is used. A protective film formed of any appropriate material can be used as the protective film. Examples of the protective film include plastic films formed of polyvinyl chloride, a vinyl chloride copolymer, polyethylene terephthalate, polybutylene terephthalate, polyurethane, a vinyl ethylene acetate copolymer, an ionomer resin, an ethylene-(meth)acrylic acid copolymer, an ethylene-(meth)acrylic acid ester copolymer, polystyrene, polycarbonate, or the like, each of which is subjected to peeling treatment with a silicone-based, long-chain alkyl-based, fluorine-based, aliphatic amide-based, or silica-based peeling agent. In addition, the polyolefin resin-based film formed of polyethylene, polypropylene, polybutene, polybutadiene, polymethylpentene, or the like, has releasing property even without using a releasing treatment agent, and hence, the film alone can be used as a protective film.

The thickness of the protective film is preferably 1 to 100 μm or more preferably 10 to 100 μm. Any appropriate method can be adopted as a method of forming the protective film to such an extent that the object of the present invention can be achieved. The protective film can be formed by, for example, an injection molding method, an extrusion molding method, or a blow molding method.

The pressure-sensitive adhesive tape of the present invention can be produced by forming the oblique columnar structures on the surface of the support. Any appropriate method can be adopted as a method of forming the oblique columnar structures. An oblique deposition process is preferred.

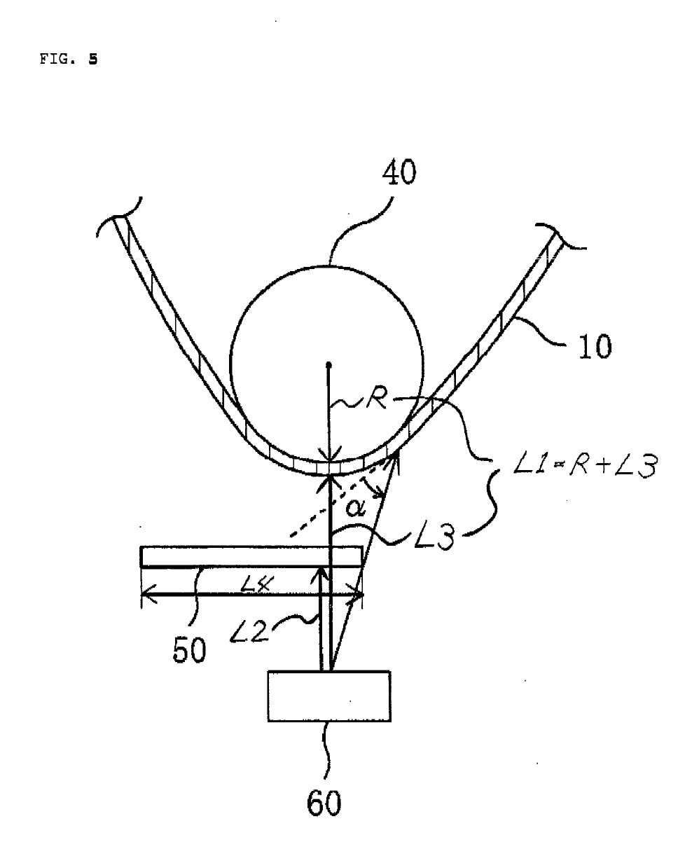

Any appropriate oblique deposition technique can be adopted as the oblique deposition process. For example, a method described in JP 08-27561 A can be adopted. The oblique deposition process is preferably performed by depositing a deposition material from the vapor onto the support delivered by a roll with a vacuum deposition apparatus. In a preferred embodiment, as illustrated in FIG. 5, when the deposition material as a deposition source 60 is vaporized or sublimated by heating so as to be caused to adhere to the surface of the support 10 placed at a distant position in a chamber evacuated to a vacuum, a shield 50 is used, and the deposition material is deposited from the vapor while being tilted relative to the support 10. When the deposition material is deposited from the vapor while being tilted relative to the support 10, the oblique columnar structures 30 tilted relative to the surface of the support 10 are formed. In this case, the support 10 is delivered by a deposition roll 40.

Any appropriate method can be adopted as a method of heating and vaporizing the above deposition material. The material is heated and vaporized by a method such as resistance heating, electron beams irradiation, high-frequency induction, or laser irradiation. The electron beams irradiation are preferred.

Any appropriate condition can be adopted as a condition for the oblique deposition process. Conditions can be set by appropriately changing, for example, the degree of vacuum of the chamber, a deposition time, heating conditions (such as the output current of, and an accelerating voltage for, electron beams), and a substrate temperature.

Any appropriate material can be adopted as the above deposition material. For example, there may be used: metals such as aluminum, zinc, gold, silver, platinum, nickel, chromium, copper, platinum, and indium; inorganic materials such as sapphire, silicon carbide (SiC), and gallium nitride (GaN); and oxides such as silicon monoxide (SiO), silicon dioxide (SiO₂), aluminum oxide (Al₂O₃), cerium oxide (CeO₂), chromium oxide (Cr₂O₃), gallium oxide (Ga₂O₃), hafnium oxide (HfO₂), tantalum pentoxide (Ta₂O₅), yttrium oxide (Y₂O₃), tungsten oxide (WO₃), titanium monoxide (TiO), titanium dioxide (TiO₂), titanium pentoxide (Ti₃O₅), nickel oxide (NiO), magnesium oxide (MgO), ITO (In₂O₃+SnO₂), niobium pentoxide (Nb₂O₅), zinc oxide (ZnO), and zirconium oxide (ZrO₂). Further, there may be used: polyimides; fluorine-based materials such as aluminum fluoride, calcium fluoride, serium fluoride, lanthanum fluoride, lithium fluoride, magnesium fluoride, neodymium fluoride, and sodium fluoride; resins such as silicone; and the like. Those materials may be used alone or in a mixture, or there may be adopted a multilayer structure of two or more layers. In particular, there are suitably used oxides such as silicon dioxide (SiO₂) and titanium dioxide (TiO₂) which are hydrophilic materials.

The method of producing a pressure-sensitive adhesive tape of the present invention is a method of producing, on the surface of a support, a pressure-sensitive adhesive tape including an assembly layer of oblique columnar structures each protruding at an elevation angle of less than 90° from the surface of the support, the method including forming the oblique columnar structures on the surface of the support by an oblique deposition process.

Any appropriate oblique deposition technique can be adopted as the oblique deposition process. For example, a method described in JP 08-27561 A can be adopted. A vacuum deposition apparatus is preferably used. It is also preferred that the oblique deposition process be performed by depositing a deposition material from the vapor onto the support delivered by a roll. It is also preferred that the deposition material be obliquely deposited from the vapor onto the support by providing a partial shield between a deposition source and the support. The term “partial shield” as used herein refers to a state where, upon placement of a shield in a space between the deposition source and the support, the shield is not placed so that the support may be completely hidden when viewed from the deposition source. That is, the term refers to a state where the shield is placed so that at least part of the support may appear when viewed from the deposition source.

In a preferred embodiment, as illustrated in FIG. 5, when the deposition material as the deposition source 60 is vaporized or sublimated by heating so as to be caused to adhere to the surface of the support 10 placed at a distant position in the chamber evacuated to a vacuum, the shield 50 is used, and the deposition material is deposited from the vapor while being tilted relative to the support 10. When the deposition material is deposited from the vapor while being tilted relative to the support 10, the oblique columnar structures 30 tilted relative to the surface of the support 10 are formed. In this case, the support 10 is delivered by the deposition roll 40. When such vacuum deposition apparatus as illustrated in FIG. 5 is used, a radius R of the deposition roll and a shortest distance L3 from the surface of the deposition roll to the deposition source each play a particularly important role in the design of the apparatus so that the surface of the support can be provided with the assembly layer of the oblique columnar structures each protruding at an elevation angle of less than 90° from the surface of the support and the oblique columnar structures may each be controlled to have an aspect ratio of 1 or more.

When such vacuum deposition apparatus as illustrated in FIG. 5 is used, any appropriate radius can be adopted as the radius R of the deposition roll as long as the surface of the support can be provided with the assembly layer of the oblique columnar structures each protruding at an elevation angle of less than 90° from the surface of the support and the oblique columnar structures can each be controlled to have an aspect ratio of 1 or more. The radius R of the deposition roll is preferably 0.1 to 5 m or more preferably 0.2 to 1 m in order that an effect of the present invention may be efficiently expressed.

When such vacuum deposition apparatus as illustrated in FIG. 5 is used, any appropriate distance can be adopted as the shortest distance L3 from the surface of the deposition roll to the deposition source as long as the surface of the support can be provided with the assembly layer of the oblique columnar structures each protruding at an elevation angle of less than 90° from the surface of the support and the oblique columnar structures can each be controlled to have an aspect ratio of 1 or more. The shortest distance L3 from the surface of the deposition roll to the deposition source is preferably 0.1 to 5 m, or more preferably 0.3 to 3 m in order that the effect of the present invention may be efficiently expressed.

When such vacuum deposition apparatus as illustrated in FIG. 5 is used, any appropriate distance can be adopted as a shortest distance L1 from the center of the deposition roll to the deposition source as long as the surface of the support can be provided with the assembly layer of the oblique columnar structures each protruding at an elevation angle of less than 90° from the surface of the support and the oblique columnar structures can each be controlled to have an aspect ratio of 1 or more. It should be noted that the L1 is a length determined by L1=R+L3. Therefore, the shortest distance L1 from the center of the deposition roll to the deposition source is preferably 0.2 to 10 m, or more preferably 0.5 to 4 m in order that the effect of the present invention may be efficiently expressed.

When such vacuum deposition apparatus as illustrated in FIG. 5 is used, any appropriate distance can be adopted as a shortest distance L2 from the shield to the deposition source as long as the surface of the support can be provided with the assembly layer of the oblique columnar structures each protruding at an elevation angle of less than 90° from the surface of the support and the oblique columnar structures can each be controlled to have an aspect ratio of 1 or more. Although the L2 is a length that can be set depending on the L3, in general, the L2 is preferably one half or more, or more preferably two thirds or more, of the L3 in order that the effect of the present invention may be efficiently expressed. When the L2 is smaller than the foregoing, a deposited film is apt to be formed isotropically, and hence it may be difficult to control the angle and the aspect ratio described above.

When such vacuum deposition apparatus as illustrated in FIG. 5 is used, any appropriate distance can be adopted as a length L4 of the shield as long as the surface of the support can be provided with the assembly layer of the oblique columnar structures each protruding at an elevation angle of less than 90° from the surface of the support and the oblique columnar structures can each be controlled to have an aspect ratio of 1 or more. Although the L4 is a length that can be set depending on the R, a possible preferred setting is R<L4<2R because a deposition angle must be achieved. The L4 is preferably 0.1 to 10 m or more preferably 0.2 to 2 m. In addition, to be specific, the length L4 of the shield is adjusted so that the surface of the support may be provided with the oblique columnar structures each protruding at an elevation angle α of less than 90° from the surface of the support, preferably 10 to 85°, more preferably 20 to 80°, or still more preferably 30 to 70°. In the case of FIG. 5, the position of the right end of the shield 50 is adjusted in a horizontal direction.

The ultimate pressure in the above vacuum deposition apparatus is preferably 1×10⁻³ torr or less, more preferably 5×10⁻⁴ torr or less, or still more preferably 1×10⁻⁴ torr or less. When the ultimate pressure in the above vacuum deposition apparatus deviates from the above range, it may be unable to form the oblique columnar structures with which the effect of the present invention can be sufficiently exerted.

The line rate at which the support is delivered in the above vacuum deposition apparatus has only to be set to any appropriate rate in consideration of, for example, the size of the apparatus so that the surface of the support can be provided with the assembly layer of the oblique columnar structures each protruding at an elevation angle of less than 90° from the surface of the support and the oblique columnar structures can each be controlled to have an aspect ratio of 1 or more.

Any appropriate method can be adopted for the vapor deposition of the deposition material in the above vacuum deposition apparatus as long as the deposition material can be heated and vaporized by the method. The material is heated and vaporized by a method such as resistance heating, electron beams irradiation, high-frequency induction, or laser irradiation. The vapor deposition of the deposition material in the above vacuum deposition apparatus is preferably performed by heating and vaporization with the electron beams irradiation.

The emission current of the above electron beams has only to be set to any appropriate emission current in consideration of, for example, the size of the apparatus so that the surface of the support can be provided with the assembly layer of the oblique columnar structures each protruding at an elevation angle of less than 90° from the surface of the support and the oblique columnar structures can each be controlled to have an aspect ratio of 1 or more.

Any appropriate condition as well as the above conditions can be adopted as a condition for the oblique deposition process. Conditions can be set by appropriately changing, for example, a deposition time and a substrate temperature.

Any appropriate material can be adopted as the above deposition material. For example, there may be used: metals such as aluminum, zinc, gold, silver, platinum, nickel, chromium, copper, platinum, and indium; inorganic materials such as sapphire, silicon carbide (SiC), and gallium nitride (GaN); and oxides such as silicon monoxide (SiO), silicon dioxide (SiO₂), aluminum oxide (Al₂O₃), cerium oxide (CeO₂), chromium oxide (Cr₂O₃), gallium oxide (Ga₂O₃), hafnium oxide (HfO₂), tantalum pentoxide (Ta₂O₅), yttrium oxide (Y₂O₃), tungsten oxide (WO₃), titanium monoxide (TiO), titanium dioxide (TiO₂), titanium pentoxide (Ti₃O₅), nickel oxide (NiO), magnesium oxide (MgO), ITO (In₂O₃+SnO₂), niobium pentoxide (Nb₂O₅), zinc oxide (ZnO), and zirconium oxide (ZrO₂). Further, there may be used: polyimides; fluorine-based materials such as aluminum fluoride, calcium fluoride, serium fluoride, lanthanum fluoride, lithium fluoride, magnesium fluoride, neodymium fluoride, and sodium fluoride; resins such as silicone; and the like. Those materials may be used alone or in a mixture, or there may be adopted a multilayer structure of two or more layers. In particular, there are suitably used oxides such as silicon dioxide (SiO₂) and titanium dioxide (TiO₂) which are hydrophilic materials.

The pressure-sensitive adhesive tape of the present invention or the pressure-sensitive adhesive tape obtained by the production method of the present invention can be used in any appropriate application. The pressure-sensitive adhesive tape can be preferably used in applications where heat resistance and a cohesive force are required such as applications for the production of electronic parts, structures, and automobiles. The pressure-sensitive adhesive tape is particularly suitably used in applications where peeling is needed such as applications for the production of an electronic part, a semiconductor device, or an electronic part for, for example, a flat display such as an LCD or PDP, because the pressure-sensitive adhesive tape does not cause a problem of any adhesive residue upon peeling from an adherend.

The pressure-sensitive adhesive tape of the present invention or the pressure-sensitive adhesive tape obtained by the production method of the present invention can be used as a cleaning member.

Any appropriate application can be adopted as an application of the cleaning member. The member is preferably used for removing foreign matter on a substrate or removing foreign matter in a substrate-treating apparatus. To be more specific, the member is suitably used for applications in the cleaning of substrate-treating apparatuses that detest minute foreign matter such as an apparatus for producing, for example, a semiconductor, flat panel display, or printed substrate and an inspection apparatus.

Any appropriate conveying member is used as the support when cleaning is performed by conveying the cleaning member in a substrate-treating apparatus. That is, the surface of the conveying member is provided with the assembly layer of the oblique columnar structures each protruding at an elevation angle of less than 90° from the surface of the support. When such cleaning member is conveyed in the substrate-treating apparatus so as to be brought into contact with, and moved toward, a site to be cleaned, foreign matter adhering to the inside of the above apparatus can be simply and reliably removed by cleaning without causing any trouble in the conveyance. Examples of the conveying member include substrates such as a semiconductor wafer, a substrate for a flat panel display such as an LCD or PDP, any other compact disk, and an MR head.

Any appropriate apparatus can be adopted as the substrate-treating apparatus with which dusting is performed. There are exemplified an exposure apparatus, a photoresist coating apparatus, a development apparatus, an ashing apparatus, a dry etching apparatus, an ion implantation apparatus, a PVD apparatus, a CVD apparatus, an appearance testing apparatus, and a wafer prover.

### EXAMPLES

Hereinafter, the present invention is described more specifically by way of examples. However, the present invention is not limited by those examples. In addition, the term “part(s)” in the examples refers to “part(s) by weight”.

### [Oblique Deposition Process]

A winding-up, electron-beam (EB) vacuum deposition apparatus illustrated in FIG. 5 was used in the formation of the oblique columnar structures. The radius R of the deposition roll was 300 mm, the shortest distance L1 from the center of the deposition roll to the deposition source was 820 mm, the shortest distance L2 from the shield to the deposition source was 420 mm, and the shortest distance L3 from the surface of the deposition roll to the deposition source was 520 mm, and the length of the shield was adjusted so that a deposition incidence angle might be 60°. The oblique columnar structures were produced by using a polyimide film having a thickness of 25 μm (Kapton 100H manufactured by DU PONT-TORAY CO., LTD.) as the support and silicon dioxide (SiO₂) as the deposition source under conditions of an ultimate pressure in the chamber of 1×10⁻⁴ torr, a line rate of 0.22 m/min, and a deposition incidence angle of 60°.

### [Water Contact Angle and Surface Free Energy]

A contact angle was measured with each of water and methylene iodide with respect to the surface of the support, and surface free energy was calculated from the above equation (1).

### [Aspect Ratio]

The aspect ratio of each of the oblique columnar structures was calculated as a ratio “length/diameter” obtained by measuring the surface diameter and length of the oblique columnar structure by surface and sectional SEM observation.

### [Height]

The height of each of the oblique columnar structures was measured by sectional SEM observation.

### [Pressure-Sensitive Adhesiveness and Adhesive Residue]

A pressure-sensitive adhesive tape was press-contacted with and stuck to a stainless plate by reciprocating a 2-kg roller once on the stainless plate. After the test piece had been left to stand at 200° C. for 1 hour, the pressure-sensitive adhesive tape was peeled in the direction at 90° from the stainless plate, and whether or not the pressure-sensitive adhesive tape could be peeled without leaving a pressure-sensitive adhesive on the stainless plate was visually examined.

### [Dusting Performance]

A silicon powder having an average particle diameter of 0.5 μm was caused to uniformly adhere onto an 8-inch silicon wafer so that the number of particles might be about 10,000. Next, the pressure-sensitive adhesive tape having the oblique columnar structures was stuck onto the 8-inch silicon water to which the silicon powder had adhered, and the tape was brought into contact for 1 minute. After a lapse of 1 minute, the pressure-sensitive adhesive tape was removed, and was then evaluated for its dusting performance by measuring the number of the silicon powder particles having an average particle diameter of 0.5 μm with a particle counter (SurfScan-6200 manufactured by KLA-Tencor Corporation). The measurement was performed three times, and the average of the three measured values was determined.

### Example 1

The oblique columnar structures were formed on the support by evaporating SiO₂ as the deposition source by setting an EB output (emission current) to 300 mA. As a result, a pressure-sensitive adhesive tape (1) was obtained.

Table 1 shows the results of the evaluation.

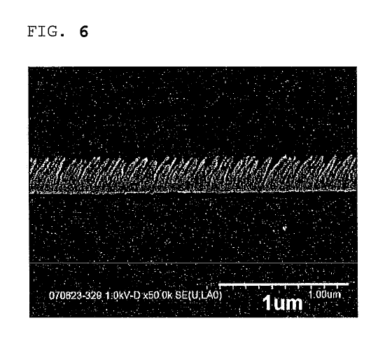

In addition, FIG. 6 shows a sectional SEM photograph.

### Example 2

The oblique columnar structures were formed on the support by evaporating SiO₂ as the deposition source in the same manner as in Example 1 except that an EB output (emission current) was set to 400 mA. As a result, a pressure-sensitive adhesive tape (2) was obtained.

Table 1 shows the results of the evaluation.

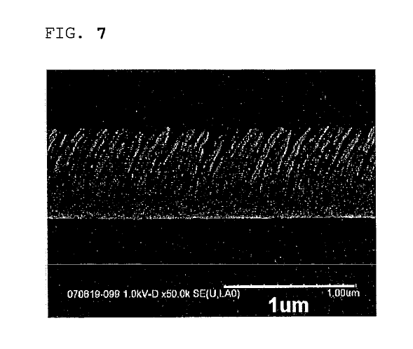

In addition, FIG. 7 shows a sectional SEM photograph.

### Example 3

The oblique columnar structures were formed on the support by evaporating SiO₂ as the deposition source in the same manner as in Example 1 except that an EB output (emission current) was set to 400 mA and an ultimate pressure was set to 4×10⁻⁵ torr. As a result, a pressure-sensitive adhesive tape (3) was obtained.

Table 1 shows the results of the evaluation.

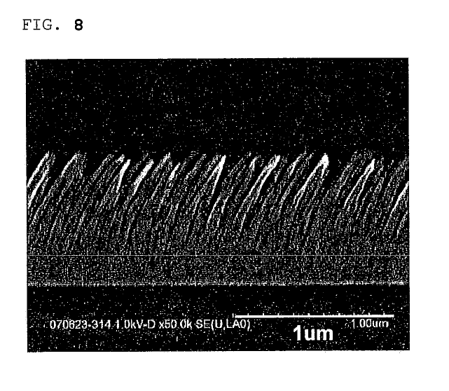

In addition, FIG. 8 shows a sectional SEM photograph.

### Comparative Example 1

The oblique columnar structures were formed on the support by evaporating SiO₂ as the deposition source in the same manner as in Example 1 except that an EB output (emission current) was set to 100 mA.

Table 1 shows the results of the evaluation.

### Comparative Example 2

The oblique columnar structures were formed on the support by evaporating SiO₂ as the deposition source in the same manner as in Example 1 except that an EB output (emission current) was set to 200 mA.

Table 1 shows the results of the evaluation.

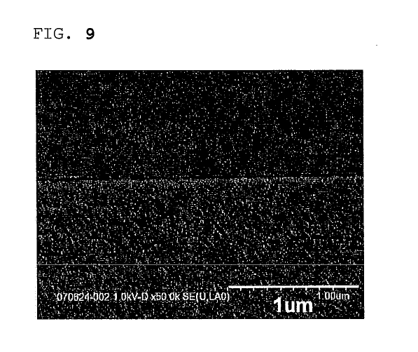

In addition, FIG. 9 shows a sectional SEM photograph.

### Comparative Example 3

2 parts of a polyisocyanate compound (manufactured by Nippon Polyurethane Industry Co., Ltd., trade name: Colonate L) and 0.6 part of an epoxy-based compound (manufactured by MITSUBISHI GAS CHEMICAL COMPANY, INC., trade name: TETRAD-C) were uniformly mixed into 100 parts of an acrylic polymer obtained from a monomer mixed liquid formed of 100 parts of butyl acrylate and 3 parts of acrylic acid. As a result, an acryl-based pressure-sensitive adhesive solution was prepared.

One surface of a polyester film (manufactured by Mitsubishi Chemical Polyester Film Corporation, trade name: MRF50, thickness 50 μm, width 250 mm) was treated with a silicone-based releasing agent. The surface treated with the silicone-based releasing agent was coated with the above pressure-sensitive adhesive solution so that the solution might have a thickness of 10 μm after its drying. Then, the solution was dried. The resultant was laminated on a polyimide film having a thickness of 25 μm (Kapton 100H manufactured by DU PONT-TORAY CO., LTD.). As a result, a pressure-sensitive adhesive tape was produced.

Table 1 shows the results of the evaluation.

### Example 4

The oblique columnar structures were formed on the support by evaporating SiO₂ as the deposition source in the same manner as in Example 1 except that the line rate was set to 1.68 m/min. As a result, a pressure-sensitive adhesive tape (4) was obtained.

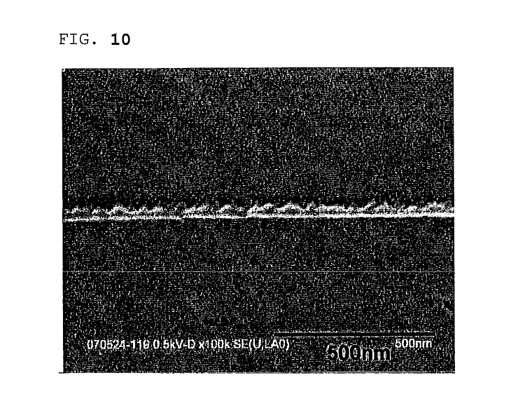

FIG. 10 shows a sectional SEM photograph.

TABLE 1

| | | | | Comparative | Comparative | Comparative |
|---|---|---|---|---|---|---|
| | Example 1 | Example 2 | Example 3 | Example 1 | Example 2 | Example 3 |
| Water contact | 8.0 | 5.3 | 3.8 | 55.3 | 30.4 | 107.1 |
| angle (°) | | | | | | |
| Surface free | 75.1 | 75.7 | 76.0 | 51.0 | 65.0 | 22.0 |
| energy | | | | | | |
| (mJ/m²) | | | | | | |
| Tilt angle (°) | 60 | 60 | 60 | Not formed | 60 | — |
| Length (nm) | 200 | 500 | 600 | — | 10 | — |
| Diameter (nm) | 200 | 200 | 200 | — | 200 | — |
| Aspect ratio | 1 | 2.5 | 3 | — | 0.05 | — |
| Adhesive | No | No | No | Does not | Does not | Adhesive |
| residue | adhesive | adhesive | adhesive | stick to | stick to | residue is |
| characteristic | residue | residue | residue | stainless | stainless | generated |
| | | | | plate | plate | |
| Dusting | 80 | 90 | 95 | 20 | 40 | 60 |
| performance | | | | | | |
| (%) | | | | | | |

Each of the pressure-sensitive adhesive tapes (1) to (4) obtained in Examples 1 to 4 had a needed pressure-sensitive adhesive force for an adherend, was able to remove even foreign matter at a submicron level without contaminating a cleaning site, was excellent in heat resistance, exerted a sufficient pressure-sensitive adhesive force and a sufficient cohesive force even at a high temperature, and was able to be easily peeled without generating any adhesive residue on the adherend upon peeling from the adherend after its use.

### INDUSTRIAL APPLICABILITY

The pressure-sensitive adhesive tape of the present invention and the pressure-sensitive adhesive tape obtained by the production method of the present invention are each suitably used in cleaning any one of the various substrate-treating apparatuses such as a production apparatus and an inspection apparatus.

1. A pressure-sensitive adhesive tape comprising, on a surface of a support, an assembly layer of oblique columnar structures each protruding at an elevation angle of less than 90° from the surface of the support, the oblique columnar structures each having an aspect ratio of 1 or more.

2. A pressure-sensitive adhesive tape according to claim 1, wherein the oblique columnar structures each have a length of 100 nm or more.

3. A pressure-sensitive adhesive tape according to claim 1, wherein the number of the oblique columnar structures per unit area of the surface of the support is 1×10⁸ structures/cm² or more.

4. A pressure-sensitive adhesive tape according to claim 1, wherein a surface of the assembly layer has a water contact angle of 10° or less.

5. A pressure-sensitive adhesive tape according to claim 1, wherein the assembly layer comprises a cleaning layer.

6. A pressure-sensitive adhesive tape according to claim 1, wherein the pressure-sensitive adhesive tape is used in producing an electronic part.

7. A method of producing, on a surface of a support, a pressure-sensitive adhesive tape including an assembly layer of oblique columnar structures each protruding at an elevation angle of less than 90° from the surface of the support, the oblique columnar structures each having an aspect ratio of 1 or more, the method comprising forming the oblique columnar structures on the surface of the support by an oblique deposition process.

8. A method of producing a pressure-sensitive adhesive tape according to claim 7, wherein a vacuum deposition apparatus is used in the oblique deposition process.

9. A method of producing a pressure-sensitive adhesive tape according to claim 8, wherein an ultimate pressure in the vacuum deposition apparatus is 1×10⁻³ ton or less.

10. A method of producing a pressure-sensitive adhesive tape according to claim 8, wherein vapor deposition of a deposition material in the vacuum deposition apparatus is performed by heating and vaporization with electron beams.

11. A method of producing a pressure-sensitive adhesive tape according to claim 7, wherein the oblique deposition process is performed by depositing a deposition material from the vapor onto the support delivered by a roll.

12. A method of producing a pressure-sensitive adhesive tape according to claim 7, wherein the oblique deposition process involves obliquely depositing a deposition material from the vapor onto the support by providing a partial shield between a deposition source and the support.

13. A method of producing a pressure-sensitive adhesive tape according to claim 7, wherein the oblique columnar structures each have a length of 100 nm or more.

14. A method of producing a pressure-sensitive adhesive tape according to claim 7, wherein the number of the oblique columnar structures per unit area of the surface of the support is 1×10⁸ structures/cm² or more.

15. A method of producing a pressure-sensitive adhesive tape according to claim 7, wherein a surface of the assembly layer has a water contact angle of 10° or less.

16. A method of producing a pressure-sensitive adhesive tape according to claim 7, wherein the assembly layer comprises a cleaning layer.

17. A method of producing a pressure-sensitive adhesive tape according to claim 7, wherein an obtained pressure-sensitive adhesive tape is used in producing an electronic part.
